(19) United States
(12) Patent Application Publication
(10) Pub. No.: US 2003/0230229 A1
(43) Pub. Date: Dec. 18, 2003

(54) Adjustable loop bookmark

(76) Inventor: Marjorie Monroe, Wilkeson, WA (US)

Correspondence Address: LAW OFFICE OF RICHARD C. MARTIN, Suite D-2, 6919 Lakewood Dr. W., Tacoma, WA, 98467, US

(21) Appl. No.: 10/171,789

(22) Filed: Jun. 17, 2002

(51) Int. Cl. B42D 9/00

(52) U.S. Cl. 116/234

(57) ABSTRACT

An adjustable loop bookmark assisting the reader in marking the page in a book. The adjustable loop bookmark includes a folded cord which is knotted at one and includes a plurality of beads moveably located to adjust the size of the adjustable loop. The beads are used to vary the size of the loop, thus making the bookmark adjustable in size to accommodate varying sizes of books, fitting snugly around the marked pages of the book. The adjustable loop may be loosened so that a new page may be marked, without having the need for the adjustable loop bookmark to leave, or be placed out of the book.

### BACKGROUND OF THE INVENTION

1. Field of Invention

The present invention pertains generally to bookmarks and, more particularly, to an adjustable loop bookmark assisting the reader in marking the page in the book to which the reader has read, without the concern of having the bookmark fall out of the book.

Bookmarks are commonly known, from the simplest to the more complex. The simplest bookmarks include slips of paper, cardboard, strings and cords, however, these bookmarks are not anchored and can easily fall out of the book. Other bookmarks employ fastening members, however, these bookmarks leave undesirable impressions on the books and harm the contact surfaces of books. More complex bookmarks allow marking of the particular line on the page, however, these bookmarks are bulky and burdensome.

2. Description of the Related Art

U.S. Pat. No. 5,458,081 to Reichert discloses an adjustable bookmark including a folded cord member consisting of a size adjusting means and two free ends. The two free ends extend, with one end member extending between a front cover and first page of a book, and the second end member extending between the pages to be marked.

The above-listed and other prior art bookmarks are prone to falling out of the book, as they do not provide a means to anchor the bookmark to the book. And prior art bookmarks that fasten to the book leave undesirable impressions.

Consequently, a need exists for a bookmark which avoids the disadvantages of prior art bookmarks. The present invention provides an improved bookmark designed to satisfy this need. The bookmark of the present invention is of a substantially simpler construction than those of the prior art. The advantages of the present invention provide an improved bookmark that can be securely anchored to a book in an unobtrusive and aesthetically pleasing fashion.

### SUMMARY OF THE INVENTION

It is the object of the present invention to provide an improved bookmark which can be securely anchored to a book and can adjustably mark a specific page of interest, while being simple in form and function, with minimum elements required as compared to the prior at, and which is inexpensive to manufacture and which is aesthetically pleasing.

Another object of the invention is to provide a bookmark which is anchored to the book, which bookmark never needs to be placed outside of the book and which is not prone to falling out of the book.

Another object of the invention is to provide a transferrable bookmark which never needs to leave the book.

Yet another object of the invention is to provide a bookmark which is unlikely to fall out of the book or become lost in the pages of a book.

Another object of the invention is to provide an adjustable bookmark for varying sizes of books.

Yet another object of the invention is to provide a bookmark that is capable of marking two different locations of the book concurrently.

Another object of the invention is to provide a quick method for marking the page of the book.

Other objects, aspects and advantages of the present invention will be apparent from the detailed description, considered in conjunction with the drawings, as follows:

### BRIEF DESCRIPTION OF THE DRAWINGS

FIG. 1 is a perspective view of the bookmark inserted into a book, with the adjusting member adjusted to fit the size of the book.

FIG. 2 is an elongated perspective view of the bookmark.

FIG. 3 is an elongated perspective view of the bookmark, with the adjuster means located at the stopper means at the second end.

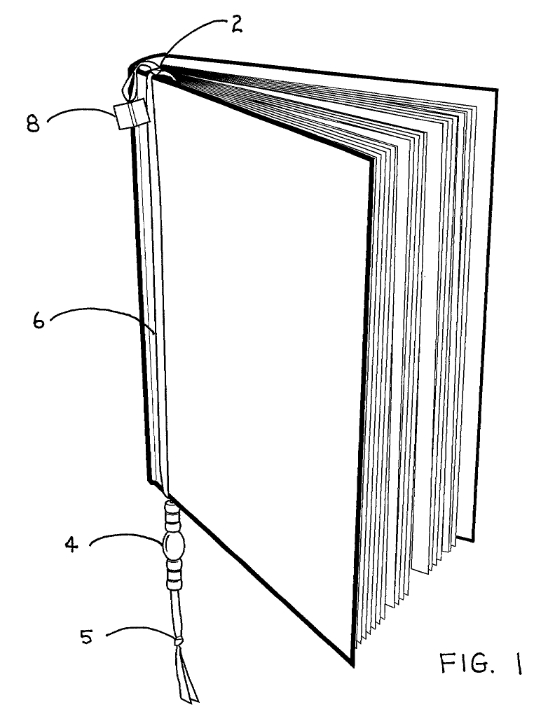

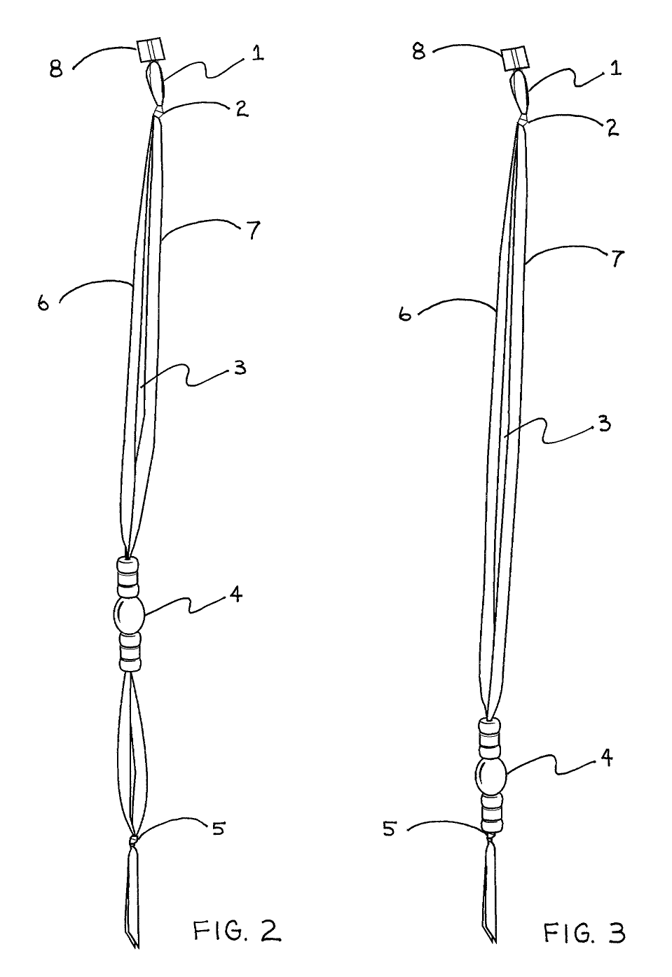

### DETAILED DESCRIPTION OF THE INVENTION

The preferred embodiment of the Adjustable Loop Bookmark Invention comprises an elongated, flexible cord member 1, made of a ribbon material. The cord member 1 may be made of any suitable material such as string, satin, nylon, polyester, plastic, cloth, or leather. The cord member 1 is folded and includes a stopper means 2 at the folded end or first end. The cord member 1 may also be constructed of two pieces that are joined together. The stopper means 2 is shown as a knot, however, the stopper means 2 may also be ornamented or consist of a stitch. The cord member 1 includes a second stopper means 5 at the free end or second end. The stopper means 5 is shown as a knot, however, the stopper means 5 may also be ornamented or comprise of a stitch. A size adjuster means 4 is moveably and frictionally located in between the stopper means 2 and the stopper means 5. The size adjuster means 4 is shown consisting of a plurality of beads moveably located to adjust the size of the adjustable loop 3. The size adjuster means may consist of any object that may be moveably and frictionally located to be moved up and down the cord member 1 and at the same time be able to bind the folded pieces of the cord member 1 snugly around the marked pages of the book. The size adjuster means 4 is used to vary the size of the loop 3, thus making the bookmark adjustable in size to accommodate varying sizes of books, fitting snugly around the marked pages of the book. The size adjuster means 4 allows the adjustable loop bookmark to snugly fit around the marked page and keeping the adjustable loop bookmark from being easily pulled out of the book. The adjustable loop 3 may be loosened so that a new page may be marked, without having the need for the adjustable loop bookmark to leave, or be placed out of the book. The adjustable loop 3 may then be readjusted to fit snugly around the newly marked page.

In addition, as the loop 3 is used to mark the pages of the book, and the loop 3 consists of two leg members, 6 and 7 respectively, two different pages of the book may be marked concurrently:

Furthermore, an additional marking object 8, is attached at one end of the adjustable loop bookmark and may be used to quickly mark a particular page of the book as an alternative method for marking a particular page in the book. The additional marking object 8 shown as a charm provides the added convenience of marking a particular page without using the adjustable loop 3 to mark a particular page if the user so chooses.

It should be apparent to those skilled in the art that various modifications may be made in the present invention, without departing from the spirit and scope of the present invention, as described in the specification and defined in the appended claims.

The embodiments of the invention in which an exclusive property or privilege is claimed are defined as follows:

1. An adjustable loop bookmark comprising:
(a) a plurality of cord members defining a stopper means at first and second ends; and
(b) a size adjuster means movably mounted within the stopper means at the first and second ends.

2. An adjustable loop bookmark, comprising:
(a) a folded cord member defining a stopper means at first and second ends; and
(b) a size adjuster means movably mounted within the stopper means at the first and second ends.

3. The adjustable loop bookmark of claim 2, wherein the folded cord member is made of ribbon stock.

4. The adjustable loop bookmark of claim 2, wherein the stopper means at the first and second ends are knots.

5. The adjustable loop bookmark of claim 2, wherein the size adjuster means comprises a plurality of beads configured to frictionally move up and down between the stopper means at the first and second ends, to adjust a loop to fit snugly around the page to be marked for varying sizes of books.

6. The adjustable loop bookmark of claim 2, further comprising a marking object fixedly attached to the first end and outwardly located relative to the stopper means at the first end.

7. An adjustable loop bookmark comprising:
(a) a folded ribbon member defining a knot at first and second ends;
(b) a plurality of beads configured to frictionally move up and down between the knots at the first and second ends;
(c) an adjustable size loop adjusted by the plurality of beads to fit snugly around the page to be marked for varying sizes of books; and
(c) a charm fixedly attached to the first end and outwardly located relative to the knot at the first end.
